(19) United States
(12) Patent Application Publication
(10) Pub. No.: US 2015/0161679 A1
(43) Pub. Date: Jun. 11, 2015

(54) Competitive Bidding Scalers For Online Advertising Auctions

(71) Applicant: Facebook, Inc., Menlo Park, CA (US)

(72) Inventors: Yi Tang, Mountain View, CA (US); Qiao Lian, Fremont, CA (US)

(73) Assignee: Facebook, Inc., Menlo Park, CA (US)

(21) Appl. No.: 14/101,077

(22) Filed: Dec. 9, 2013

(51) Int. Cl. G06Q 30/02

(52) U.S. Cl. CPC G06Q 30/0275

(57) ABSTRACT

Competitive bidding tools, including a competitive bidding scaler tool and a competitive report generator, may be implemented by an advertiser to improve their advertisement's performance in online advertising auctions. The competitive bidding scaler tool increases the bid amount associated with an advertiser's ad request when a competing advertiser submits a rival ad request to the same online advertising auction. The competitive report tool generates a competitive report for an ad request that benchmarks its performance against rival ad requests. The competitive report comprises a summary of wins and losses experienced by the ad request in an online advertising auction as well as an option to implement the competitive bidding scaler tool for the ad request.

### BACKGROUND

This disclosure relates generally to online advertising, and more specifically to implementing competitive bidding tools in an online advertising auction.

Social networks, or social utilities that enable connections between social network users (including people, businesses, and other entities), generate revenue by selling targeted advertisement space to advertising entities. Targeted advertising is more cost-effective than traditional forms of advertising because a targeted advertisement is only shown to a user demographic likely to be interested in the advertisement. For example, an advertising entity may show a targeted advertisement for tennis racquets to a person who watched a tennis match, since a person interested in tennis is more likely to buy a tennis racquet than an average person. Furthermore, the prevalence of user information on social networking websites allows advertisers to better reach target demographics, thus increasing the effectiveness of targeted advertisements. In the same example, an advertising entity utilizes information on a social network to show an advertisement for tennis racquets to a social network user who watched a tennis match and wrote about tennis racquets in a post to the social networking website.

Social networks are an ideal environment for targeted advertising, so competition for advertising space on social networks is intense. Multiple advertisers, promoting a wide variety of products and services, compete to display advertisements to social networking users by bidding in online advertising auctions run by social networking websites. Since the online advertising auctions are typically run behind closed doors, advertisers do not know who they compete against, how their bids fare against their competitors' bids, and how to outbid their rival advertisers.

### SUMMARY

Some embodiments provide a system and method for implementing competitive bidding tools, including a competitive bidding scaler and a competitive reporting tool, in online advertising auctions for an ad publishing system, such as one in a social networking environment. These competitive bidding tools assist advertisers in identifying competitors and providing strategies for outbidding their competitors.

A competitive bidding scaler tool allows an advertiser to submit a specification that identifies one or more of the advertiser's known competitors to an ad publishing system while or in addition to (e.g., before or after) submitting an ad request, which includes advertising content and a bid amount, to an online advertising auction. Furthermore, the advertiser submits to the ad publishing system a bidding scaler, which is associated with the ad request and the competing advertisers in the specification. The ad publishing system determines whether a competing advertiser listed in the specification is present in the online advertising auction, in which case the ad publishing system increases the advertiser's bid amount by applying the bidding scaler.

The competitive reporting tool generates a competitive report benchmarking the performance of an advertiser's advertisements versus their competitors' advertisements. The competitive report comprises a history of an ad request's wins and losses in online advertising auctions, including wins and losses against the advertiser's competitors. Furthermore, the competitive report includes advertisement performance metrics and can provide a competitive bidding option in which the bid is increased if a competitor's ad is in the auction, for example by using the competitive bidding scaler tool described above. Separate metrics may be provided for any ad impressions for which the competitive bidding option was triggered.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### BRIEF DESCRIPTION OF THE DRAWINGS

FIG. 1 is a network diagram of a system environment for serving targeted advertisements to users of a social networking system or other ad publishing system, in accordance with an embodiment.

FIG. 2 is a block diagram of a social networking system that allows an advertiser to use competitive bidding tools in an online advertising auction, in accordance with an embodiment.

FIG. 3 is a flow chart of a process for using a competitive bidding scaler tool, in accordance with an embodiment.

FIG. 4 is a flow chart of a process for using a competitive reporting tool, in accordance with an embodiment.

FIG. 5 is an exemplary display of a competitive report on a social networking system, in accordance with an embodiment.

### DETAILED DESCRIPTION

### Overview

Some embodiments provide a system and method for implementing competitive bidding tools, including a competitive bidding scaler and a competitive reporting tool, in online advertising auctions on an ad publishing system, such as on a social networking website. Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Architecture

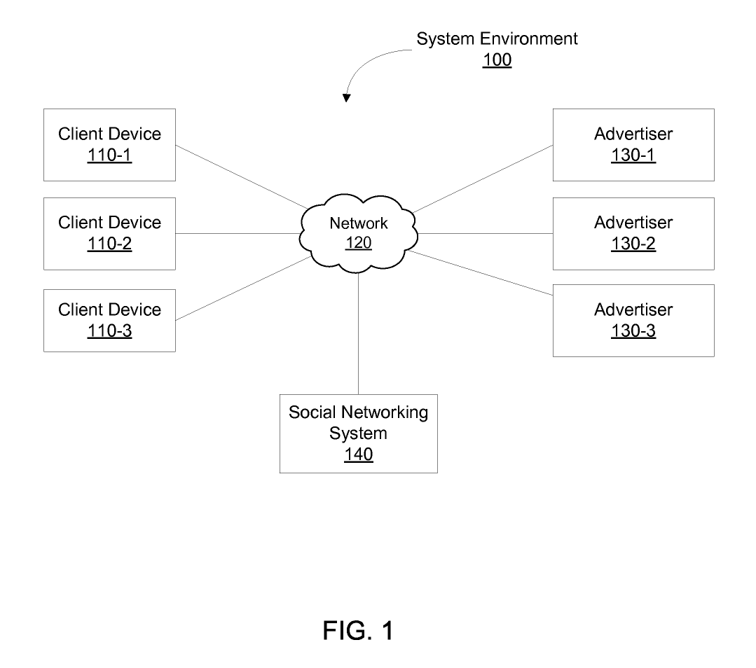

FIG. 1 is a high level block diagram of a system environment 100 suitable for implementing competitive bidding tools. The social networking system 140 is used as an example throughout this description. However, embodiments can be applied in any online advertising environment and so the social networking system 140 can be replaced with any other ad publishing system that runs online advertising auctions. For the sake of illustration, however, the social networking system will be used throughout to provide an example of one type of ad publishing system that could be used, even though the description is in no way limited to this embodiment.

The system environment 100 shown by FIG. 1 comprises one or more client devices 110, a network 120, one or more advertisers 130, and the social networking system 140. In the diagram, advertiser 130-1, advertiser 130-2, and advertiser 130-3 are advertising entities that have submitted ad requests to the same online advertising auction. To simplify the example set forth in this application, competitive bidding tools are only enabled for advertiser 130-1. In other embodiments, any number of advertisers 130 in the network may use competitive bidding tools. While client device 110-1, client device 110-2, and client device 110-3 are client devices associated with different social network users, a user may access the social network through more than one client device. Only three client devices 110 and three advertisers 130 are shown in FIG. 1 for simplicity. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

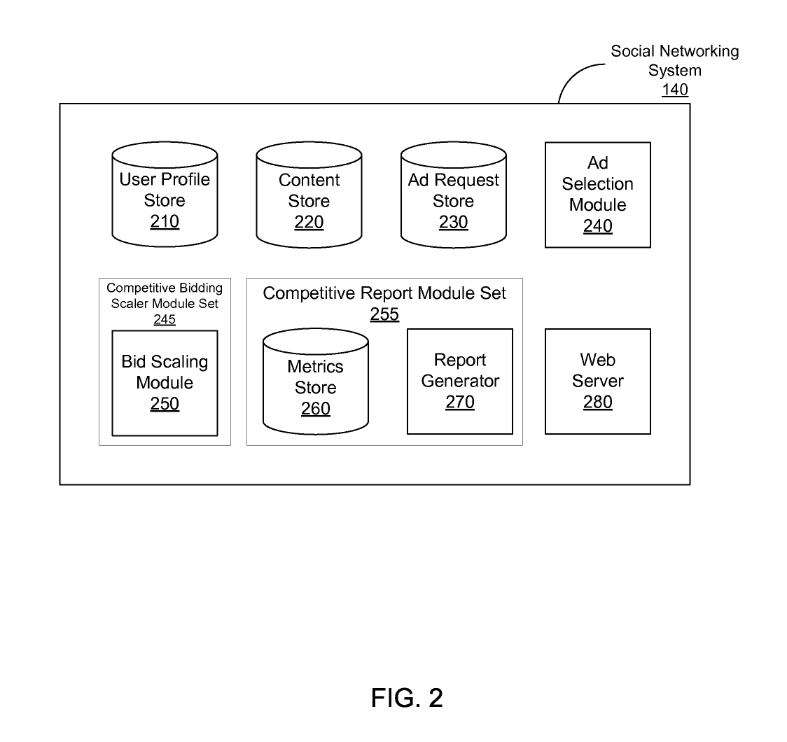

The advertisers 130 can use one or more devices that are coupled to the network 120 for communicating with the social networking system 140, which is further described below in FIG. 2. An advertiser 130 provides an ad request to the social networking system 140 and may receive from the same social networking system 140 a competitive report. The advertiser 130 may use a hardware device, a server, a personal computing device, a software database, a program loaded on a computer-readable storage medium, or any other suitable embodiment to submit an ad request and/or receive a competitive report.

FIG. 2 is an example block diagram of an architecture of the social networking system 140. The social networking system 140 shown in FIG. 2 includes a user profile store 210, a content store 220, an ad request store 230, an ad selection module 240, and a web server 280. Separate module sets may be added to the social networking system 140 to implement competitive bidding tools. In particular, a competitive bidding scaler module set 245, which includes a bid scaling module 250, may be added to the social networking system 140 to enable competitive bidding scaler tools, and a competitive reporting module set 255, which includes a metrics store 260 and a report generator 270, may be added to the social networking system 140 to enable competitive reporting tools. Module sets 245, 255 may also be implemented separately, in which case only the competitive bidding scaler tool or only the competitive reporting tool may be used in some embodiments. However, in the embodiment described in FIG. 2, both module sets 245, 255 are implemented.

In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 210. A user profile includes declarative information about the user that was explicitly shared by the user and may also include profile information inferred by the social networking system 140. In one embodiment, a user profile includes multiple data fields, each describing one or more attributes of the corresponding user of the social networking system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 140 displayed in an image.

While user profiles in the user profile store 210 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity. Furthermore, information about the entity may be expressed in an advertisement on the social networking website.

The content store 220 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 220, such as status updates, photos tagged by users to be associated with other objects in the social networking system, events, groups or applications. In some embodiments, objects are received from third-party applications or third-party applications separate from the social networking system 140. In one embodiment, objects in the content store 220 represent single pieces of content, or content “items.” Hence, users of the social networking system 140 are encouraged to communicate with each other by posting text and content items of various types of media through various communication channels. This increases the amount of interaction of users with each other and increases the frequency with which users interact within the social networking system 140.

One or more advertisement requests (“ad requests”) are included in an ad request store 230. An advertisement request includes advertisement content and a bid amount. The advertisement content comprises text, image, audio, video, or any other suitable data presented to a user as an advertisement. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, the ad request store 230 stores targeting criteria specified by the advertiser. Targeting criteria included in an advertisement request specify one or more characteristics of users eligible to be presented with content in the advertisement request. For example, targeting criteria are a filter to apply to fields of a user profile and/or actions associated with a user to identify users having user profile information or actions satisfying at least one of the targeting criteria. Hence, the targeting criteria allow an advertiser to identify groups of users matching specific targeting criteria, simplifying subsequent distribution of content to groups of users.

In one embodiment, the targeting criteria may specify actions or types of connections between a user and another user or object of the social networking system 140. The targeting criteria may also specify interactions between a user and objects performed external to the social networking system 140. For example, the targeting criteria identifies users that have taken a particular action, such as sending a message to another user, using an application, joining a group, leaving a group, joining an event, generating an event description, purchasing or reviewing a product or service using an online marketplace, seen an ad requested by a device associated with an advertiser 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

Furthermore, the ad request store 230 stores competitive bidding scaler information associated with the ad request. Competitive bidding scaler information is used to implement the competitive bidding scaler tool and comprises a specification identifying one or more competing advertisers who may submit competing ad requests as well as a bidding scaler associated with both the ad request and the specification identifying the competing advertisers.

The specification comprises information identifying at least one competing advertiser 130 or a device associated with the competing advertiser that participates in online advertising auctions. The competing advertisers 130 in the specification are typically selected by the advertiser, and typically includes competing advertisers that market a product similar to a product marketed by the advertiser or that advertises to the same demographic as the advertiser. For example, an advertiser 130-1 selling baby food may specify as a competitor a rival baby food company that competes with the advertiser for the same market share and the same user demographic. In another instance, the advertiser 130-1 selling baby food selects as a competitor a highchair company that does not directly compete with the advertiser for a share of the baby food market, but competes with the advertiser for the same user demographics of parents with newborn babies. The competing advertisers 130 identified by the advertiser can include specific companies, brands, products, etc. or can also include categories of competition, such as advertisers who market to parents of newborn babies, or advertisers who sell highchairs. Other methods of identifying competing advertisers 130 involve analyzing advertisement content. For example, a competing advertiser 130 could be identified by advertising content in an advertisement, contact information included in the advertisement, a landing page linked to the advertisement, and/or by targeting criteria associated with the advertisement. Furthermore, competing advertisers 130 may be selected based on social networking data, such as the number of mutual fans shared between two advertisers or content on the competing advertiser's user profile page. However, an advertiser 130-1 using competitive bidding tools may select any advertising entity as a competing advertiser. The advertiser 130-1 using the competitive bidding tools submits competitive bidding scaler information to the ad request store 230.

Alternatively, the social networking system 140 may automatically generate the specification identifying the advertiser's competitors 130 and/or a set of bidding scalers associated with the competitors for the advertiser 130-1 to approve or select from. For example, the social networking system 140 may determine potential competitors by measuring the number of shared fans between two advertisers, recording which other advertisers' user profiles were viewed with the advertiser's user profile, and/or any other information in user store 210 or content store 220. The social networking system 140 then presents a listing of potential competitors to the advertiser 130-1, who selects suitable competing advertisers from the listing. In another embodiment, the social networking system 140 automatically selects a set of potential competitors to be included in the specification, associates a bidding scaler with the set of competitors, and implements the competitive bidding scaler tool in an online advertising auction without advertiser input (e.g., in response to the advertiser indicating he wants to participate in competitive bidding, but wants the social networking system to automatically implement this for him).

The ad selection module 240 selects an appropriate advertisement associated with an ad request stored in the ad request store 230. In one embodiment, the ad selection module 240 selects an advertisement using an auction process, in which the ad selection module 240 hosts an online advertising auction to sell advertising space that targets a user on the social networking website. Only advertisements eligible to be shown to the viewing user associated with the client device 110-1 are submitted to the online advertising auction. Targeting criteria for the advertising space are generated using information from the user store 210 and content store 220 and are compared to targeting criteria associated with each ad request in the ad request store 230. Ad requests are selected for the online advertising auction based on their targeting criteria. In one embodiment, ad requests with targeting criteria similar to the advertising space's targeting criteria are selected for the online advertising auction.

The bid scaling module 250 applies the bidding scaler tool to an ad request associated with an advertiser using competitive bidding tools. The bid scaling module 250 detects when an ad request associated with a competing advertiser 130 is in the same online advertising auction as the ad request associated with the advertiser 130-1. The bid scaling module 250 determines the presence of competing advertisers 130 by examining targeting criteria associated with each ad request, examining identifying information (such as contact information, products, brand names, addresses, server IP addresses, geographical locations, etc) associated with each ad request, or other narrowing methods. Furthermore, the bid scaling module 250 may only examine a portion of all ad requests submitted to the online advertising auction. For example, the bid scaling module 250 may only consider the ad requests that are most likely to win the online advertising auction (e.g., the top N ad requests) or the ad requests with similar bid amounts to the advertiser's.

The bid scaling module 250 allows the advertiser 130-1 to increase or otherwise adjust the bid in an online advertising auction when it is determined that a competitor is also in the online advertising auction. For example, the module 250 may allow the advertiser 130-1 to specify a competitive bidding scaler that is used to adjust the advertiser's bid when an ad request of one of the advertiser's competitors is competing against the advertiser's ad request in an auction. In one embodiment, the module 250 multiplies the bid amount associated with an ad request by the bidding scaler for the ad request to increase the bid amount. The bidding scaler can thus be a multiplier submitted with an ad request that changes the associated bid amount.

The bidding scaler may be associated with one ad request or group of ad requests, such as an ad campaign. In one example, the advertiser 130-1 specifies that a bidding scaler of 1.5× should be applied when ad requests for both the advertiser 130-1 and 130-2 are in the same online advertising auction. The bidding scaler module 250 determines whether both advertiser 130-1 and advertiser 130-2 submit ad requests in the same online advertising auction and multiplies the bid amount associated with advertiser 130-1 by a factor of 1.5 when both advertisers 130-1 and 130-2 have a requests in the same online advertising auction. Furthermore, the bid scaling module 250 increases the bid amount during the online advertising auction such that the advertiser 130-1 does not need to withdraw and/or resubmit the ad request associated with the bid amount in the online advertising auction. In other embodiments, multiple bidding scalers may be associated with the same ad request. Many other combinations of bidding scalers and ad requests may exist in other embodiments. Furthermore, multiple bidding scalers associated with the same ad request or ad requests may be triggered for multiple reasons. For example, an advertiser 130-1 could implement a different bidding scaler for each potential competing advertiser, or implement different bidding scalers depending on the number of competing advertisers in the online advertising auction. Furthermore, the advertiser 130-1 may implement a competitive bidding scaler for a specific product or advertisement marketed by a competing advertiser 130, or for a specific brand, model, trademark, category, or other component of a competitor's business. For example, an advertiser 130-1 marketing a horror movie may only implement competitive bidding scalers against advertisements for horror movies released by a rival studio, not all advertisements for movies released by the rival studio. In another example, an advertiser 130-1 may implement a competitive bidding scaler against a competing advertiser's newest advertising campaign, but not against the competing advertiser's previous advertising campaigns.

In another embodiment, the bid scaling module 250 applies the bidding scaler tool to an ad request based on parameters other than the presence of competing ad requests. The parameters can be related to the environment in which the advertisement is shown, the user demographics associated with the advertising space, or the ad requests in the online advertising auction. For example, the advertiser associated with advertiser 130-1 can specify a parameter that allows the bid scaling module 250 to apply a bidding scaler to a bid amount only at a certain time of day. Furthermore, bidding scalers may be applied based on conditions in an online advertising auction such as the number of ad requests in the online advertising auction or the range of bid prices.

The metrics store 260 stores a set of advertisement performance metrics for each ad request. The set of advertisement performance metrics comprises auction performance metrics, social metrics, financial metrics, and competitive metrics. Auction performance metrics are metrics that describe an ad request's performance during an online auction, including, for example, a win/loss history for an ad request in a set of online advertising actions, a set of historical bid amounts for the ad request, and a specification identifying a set of competing advertisers who submitted rival ad requests to the social networking system 140. Social metrics are metrics that describe interactions social networking users have with the advertisement submitted by advertiser 130-1. In this context, interactions include the number of times users clicked on the advertisement, ‘liked’ the advertisement, became a fan of the brand, company, or product promoted by the advertisement, or otherwise expressed an affinity with the advertisement. Financial metrics quantify the cost of the ad request as well as the revenue associated with the advertisement.

Furthermore, the metrics store 260 includes competitive metrics for an ad request submitted by an advertiser 130-1 using competitive bidding tools. Competitive metrics describe the effectiveness of a competitive bidding scaler implemented by the advertiser 130-1, such as how many times the competitive bidding tool was used, which ad requests the competitive bidding tool was used against, the total cost of the bidding scaler, the total revenue generated by the bidding scaler, and how many times the application of the competitive bidding tool changed the outcome of an online advertising auction. Furthermore, the competitive metrics can describe the effect of competitive bidding tools used against competing advertisers. For example, competitive metrics include how many times bidding scalers were applied to ad requests submitted by competing advertisers, how many times ad requests submitted by an advertiser lost against rival ad requests using completive bidding tools, how many times a competing advertiser's bidding scaler resulted in a loss, and which competing advertisers included the advertiser in their specification identifying the set of competing advertisers.

The report generator 270 writes a competitive report summarizing the performance of an advertiser's ad request and benchmarks the advertiser's ad request against competing advertiser's ad requests. The report generator 270 uses auction performance, social, financial, and competitive metrics stored in the metrics store 260 to generate a competitive report, which summarizes the ad request's performance during and after an online advertising auction and includes a win/loss summary of an ad request in an online advertising auction. The report generator 270 is able to send competitive reports to the device associated with the advertiser 130-1 over the network 120 or otherwise make reports available for viewing, such as on an administrator page associated with an advertiser.

The web server 280 links the social networking system 140 via the network 120 to the one or more client devices 110, as well as to the multiple devices associated with advertisers 130. The web server 140 serves web pages, as well as other web-related content, such as JAVA®, FLASH®, XML, and so forth. The web server 280 may receive and route messages between the social networking system 140 and the client device 110, for example, instant messages, queued messages (e.g., email), text messages, short message service (SMS) messages, or messages sent using any other suitable messaging technique. A user may send a request to the web server 280 to upload information (e.g., images or videos) that are stored in the content store 220. Additionally, the web server 280 may provide application programming interface (API) functionality to send data directly to native client device operating systems, such as IOS®, ANDROID™, WEBOS® or RIM®.

### Using Competitive Bidding Scalers in an Online Advertising Auction

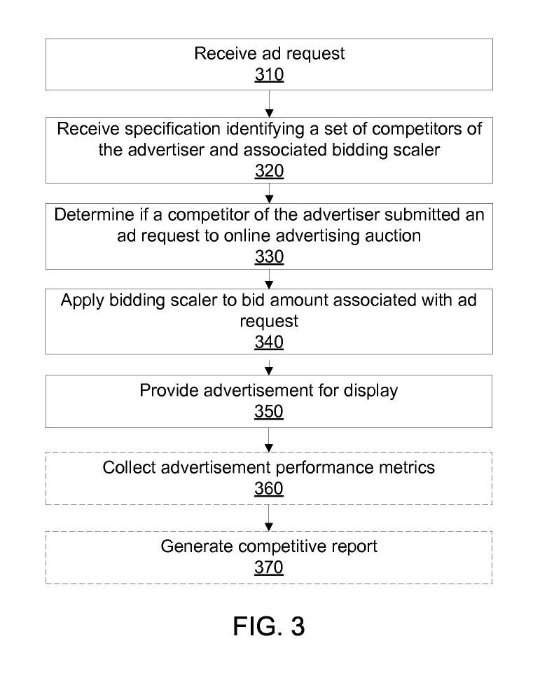

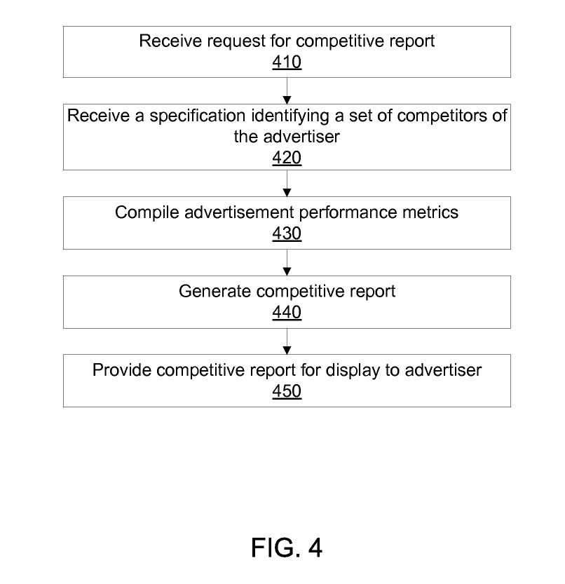

FIG. 3 illustrates a process for implementing competitive bidding scalers in an online advertising auction. In one embodiment, the process of FIG. 3 is enabled at least in part by an application executing on an ad publishing system. For example, the application may comprise computer-executable instructions stored to a non-transitory computer-readable storage medium that when executed by a processor causes the processor to perform the steps of FIG. 3 below. While the ad publishing system can be any advertising device that uses any form of user-related information as a basis for selecting advertisements to be displayed on any website, the ad publishing system can be embodied as a social networking system that selects advertisements to be displayed on, for example, a social networking website based in part on social networking information. Hence, the social networking system is used as an example of an ad publishing system in the methods of FIGS. 3 and 4, though any ad publishing system can perform the method steps.

A social networking system 140 receives 310 at least one ad request from an advertiser 130-1, wherein competitive bidding tools are implemented for the advertiser. The advertiser 130-1 generates an ad request using the social networking system to compile advertisement content, a bid, and targeting criteria associated with the advertising content into an ad request. Advertisement content can be generated by the advertiser. In one embodiment, the content is selected from a database associated with the advertiser 130-1 or directly generated by the advertiser. The advertiser 130-1 uses the social networking system to collect advertising content based on the targeting criteria and provides an appropriate ad request to the social networking system 140, on which the ad request is stored.

The social networking system receives 320 competitive bidding scaler information comprising a specification identifying a set of competing advertisers and a bidding scaler associated with both the ad request and the set of competing advertisers. This can be submitted by the advertiser to the social networking system 140, or can be generated by the social networking system itself. For example, the advertiser 130-1 may submit a bidding scaler of 2× associated with two competitors, advertisers 130-2 and 130-3, such that the bid amount submitted by the advertiser 130-1 is multiplied by 2× whenever a rival ad request from competing advertisers 130-2 or 130-3 are selected for the same online advertising auction. In another embodiment, the advertiser 130-1 can submit multiple bidding scalers that correspond to different advertisers. For example, the advertiser 130-1 could submit a bidding scaler of 2× associated with advertiser 130-2 and a bidding scaler of 3× associated with advertiser 130-3. When both an ad request from advertiser 130-1 and advertiser 130-2 are selected for the same online advertising auction, the bidding scaler of 2× is applied to the bid amount associated with advertiser 130-1. When both an ad request from advertiser 130-1 and advertiser 130-3 are selected for the same online advertising auction, the bidding scaler of 3× is applied to the bid amount associated with advertiser 130-1. Alternative combinations of multiple bidding scalers, ad requests, and competing advertisers may be manifested in different embodiments. Multiple bidding scalers for a given competitor that may also be applied according to different conditions that might be specified by the advertiser. The advertiser 130-1 sends competitive bidding information to the social networking system, in which the competitive bidding information is stored with its associated ad request.

The social networking system 140 selects an ad request for display using an online advertising auction. When the system 140 receives a request to present an advertisement to a social network user (e.g., a viewing user), the system 140 determines which demographics the user is associated with by analyzing user profile information and content information associated with the user, then retrieves candidate ad requests based on the targeting criteria associated with the candidate ad requests. In one embodiment, only candidate ad requests with similar targeting criteria as the social network user's targeting criteria are retrieved by the social networking system 140. The social networking system 140 selects candidate ad requests having targeting criteria satisfied by information associated with the user to be presented with the advertisement and hosts an online advertising auction to enter candidate ad requests into. The online advertising auction selects an advertisement for display based on the ad request's associated bid amount.

The social networking system 140 determines 330 whether an ad request selected for the online advertising auction was submitted by a competing advertiser listed in the specification identifying the set of competing advertisers, which can include an identification of competing brands, products, models, trademarks, categories of products, and other such information. In one embodiment, the system 140 identifies competing advertisers using information, such as a name, IP address, or location, associated with an ad request. In other embodiments, the system 140 analyzes a candidate ad request's targeting criteria and advertisement content to determine if the candidate ad request was is associated with a competing advertiser of the advertiser 130-1.

When the social networking system 140 determines 330 that an ad request from a competing advertiser is also present in the online advertising auction, the system 140 applies 340 a bidding scaler to the bid amount associated with the ad request from the advertiser. The system 140 retrieves the bidding scaler associated with the competing advertiser, accesses the ad request associated with the advertiser, and multiplies the bid amount in the ad request by the bidding scaler stored in the system 140. In one embodiment, the bidding scaler is a multiplier greater than 1, such that multiplying the bid amount by the bidding scaler increases, rather than decreases, the bid amount. Also, the social networking system 140 may modify the bid amount during the online advertising auction such that the ad request does not need to be reentered into the online advertising auction. In other embodiments, however, the ad request with the modified bid amount is reentered as a different ad request into the online advertising auction.

The social networking system 140 selects and provides 350 an advertisement for display to the social network user on a client device 110 associated with a user. The ad request associated with the advertisement is selected based in part on the bid amount. In one embodiment, the social networking system 140 selects the ad request based on the expected value, in which the expected value is the bid amount multiplied by the probability of the user interacting with the advertisement. The probability of the user interacting with the advertisement is based on information regarding the user's past social interactions and the user's user profile information in the social networking system 140. The advertisement displayed to the social network user may be embodied as a pop-up ad, a pop-under ad, a floating ad, an expanding ad, an interstitial ad, a banner ad, or any other form of online advertisement familiar to a person having ordinary skill in the art.

The following steps 360, 370 describe an embodiment in which a competitive reporting tool is implemented in conjunction with the competitive bidding scaler tool. While both tools are used in this example, each tool may be implemented individually, without using the other tool, during an online advertising auction. The following steps 360, 370 are not executed if the advertiser does not implement the competitive reporting tool.

The social networking system 140 collects 360 ad performance metrics related to the ad request submitted by an advertiser. Ad performance metrics can include, but are not limited to, auction performance metrics, financial metrics, competitive metrics, and social metrics. Auction performance metrics are collected by the social networking system 140, which monitors the online advertising auction. Social metrics are collected by tracking user activity on client devices 110. User activity on the client devices 110 is tracked using web cookies, tracking pixels, mobile application login events, or other online activity monitoring methods familiar to a person having ordinary skill in the art. Social metrics related to specific users can also be retrieved from databases associated with the social networking system 140.

In some embodiments, financial metrics are gathered using a holdout process. In the holdout process, an advertisement associated with an ad request selected by the social networking system 140 is not published for display to a holdout subset of social network users. The social networking users in the holdout subset are chosen randomly or pseudo-randomly by the social networking system 140. Data collected from the social networking users in the holdout subset are used as a baseline for comparative data. For example, the revenue increase attributed to an advertisement is measured by comparing the revenue generated when the advertisement is displayed to a user and the revenue generated a user in the holdout subset who is not shown the advertisement. Furthermore, comparative social metrics, such as the number of user interactions associated with an advertisement, are determined using the holdout process. Further description of the holdout process is provided in the U.S. application Ser. No. 13/658,480, filed on Oct. 23, 2012, which is hereby incorporated by reference in its entirety.

Competitive metrics can also be collected for the ad request submitted by the advertiser. Competitive metrics can be collected using the holdout process, in which the competitive bidding scaler tool is disabled for a holdout subset of online advertising auctions. Data collected from the holdout subset is compared to data collected by the non-holdout subset to determine metrics such as the number of wins in an online advertising auction attributed to the bidding scaler. In the case where competitive metrics data from competing advertisers is unavailable, the competitive report will display public data about the competing advertiser instead. For example, if the number of fans acquired as a result of a competing advertiser's advertisement is not available due to k-anonymity limitations, the competitive report may use the total number of fans acquired by the competing advertiser over the lifetime of the advertisement instead.

The social networking system 140 generates 370 a competitive report for the advertiser, which summarizes the ad request's performance and may benchmark the ad request's performance against ad requests submitted by competing advertisers. The competitive report compiles advertisement performance metrics associated with the ad request submitted by the advertiser as well as metrics associated with competing advertisers. In one embodiment, the competitive report also comprises historical information from databases associated with the social networking system 140 to supplement advertisement performance metrics. In another embodiment in which the social networking system 140 cannot use metrics associated with a competing advertiser, public information is used to generate a competitive report instead. Based on the advertisement performance metrics and the metrics associated with competing advertisers, the social networking system 140 may suggest potential competing advertisers in the competitive report and may provide an option to the implement competitive bidding scaler tool against these potential competing advertisers. For example, if metrics in the competitive report suggest that ad requests submitted by advertiser 130-1 are consistently losing to ad requests submitted by a new advertiser 130-2, which is not currently included in the specification identifying the set of competing advertisers defined by advertiser 130-1, the social networking system 140 can include a suggestion in the competitive report to include the new advertiser 130-2 in the specification. Furthermore, the competitive report may provide an option to implement the competitive bidding scaler tool against advertiser 130-2. The system 140 provides the competitive report for display.

### Generating a Competitive Report for an Ad Request

FIG. 4 illustrates a process for generating a competitive report in an online advertising auction. This embodiment includes generating a report for an advertiser that may or may not be using the competitive bidding scaler tool, and so does not require this tool or the use of bidding scalers. In one embodiment, the process of FIG. 4 is enabled at least in part by an application executing on the social networking system 140. For example, the application may comprise computer-executable instructions stored to a non-transitory computer-readable storage medium that when executed by a processor causes the processor to perform the steps of FIG. 4 below.

The social networking system 140 receives 410 a request (e.g., from an advertiser 130-1) for a competitive report relating to at least one ad request. While the example competitive report in this application is for one ad request, a competitive report may be generated for a series of ad requests, an ad campaign, or any other group of ad requests submitted to any number of online advertising auctions. In one embodiment, the social networking system 140 may generate a competitive report for an ad request without advertiser input. For example, the social networking system 140 may automatically generate a competitive report for an advertiser or an ad request new to the social networking system 140.

The social networking system 140 receives 420 a specification identifying the set of competing advertisers (e.g., from advertiser 130-1). An advertiser 130-1 selects the specification identifying one or more competing advertisers, wherein a competing advertiser typically markets a product similar to a product marketed by the advertiser or that advertises to the same demographic as the advertiser, or may be involved in a related category of competition. Furthermore, the advertiser can also indicate individual brands or products that the advertiser 130-1 may wish to specifically compete against. Competing advertisers may be selected based on information in the ad request, such as the competing advertiser's contact information, brand names or products, the advertisement's landing page, and/or targeting criteria. Also, competing advertisers may be identified based on previous auction history characteristics, such as if they competed against the advertiser in the past. However, an advertiser may select any advertising entity as a competing advertiser. While the advertiser typically selects the specification, the social networking system 140 may also suggest to the advertisers competitors to add to the specification. Alternatively, the social networking system 140 compiles a specification and generates the competitive report without advertiser input.

The social networking system 140 compiles 430 advertisement performance metrics. These can include any of the metrics described above with regard to FIG. 3. Information used to generate advertisement performance metrics is retrieved from client devices 110, devices associated with advertisers 130, and the social networking system 140. Furthermore, information may be gathered from any device, such as a database or server, connected to the network 120. The advertisement performance metrics received by the social networking system 140 may partly comprise historical data. In the case where competitive metrics data from competing advertisers is unavailable, the competitive report will display public data about the competing advertiser instead. For example, if the number of fans acquired as a result of a competing advertiser's advertisement is not available due to k-anonymity limitations, the competitive report may use the total number of fans acquired by the competing advertiser over the lifetime of the advertisement instead.

The social networking system 140 generates 440 a competitive report, which comprises advertisement performance metrics. The report can be generated as described above for FIG. 3. The competitive report comprises advertisement performance metrics, which may be communicated to the advertiser in text, a graph, a table, a picture, a video, an audio clip, and/or an interactive display. Furthermore, the competitive report may include information related to one or more competing advertisers, such a link to a competitor's website, a user profile page on the social network, and/or information identifying a set of the competing advertiser's competitors. If the advertiser is not using the competitive bidding option at the time of the report, the competitive report may provide an option to initiate competitive bidding for the ad request associated with the competitive report. Furthermore, the competitive report may include one or more competitive bidding suggestions for potential competitors and potential bidding scalers that would improve the ad request's performance in online advertising auctions. In another embodiment, the social networking system 140 applies the competitive bidding suggestions with or without advertiser input.

The social networking system 140 provides 450 a competitive report for display to the advertiser. The report may be displayed on a web page accessible to the advertiser, attached to an email sent to the advertiser, sent to a device associated with the advertiser 130-1, or transmitted to the advertiser in another electronic communication method familiar to a person having ordinary skill in the art.

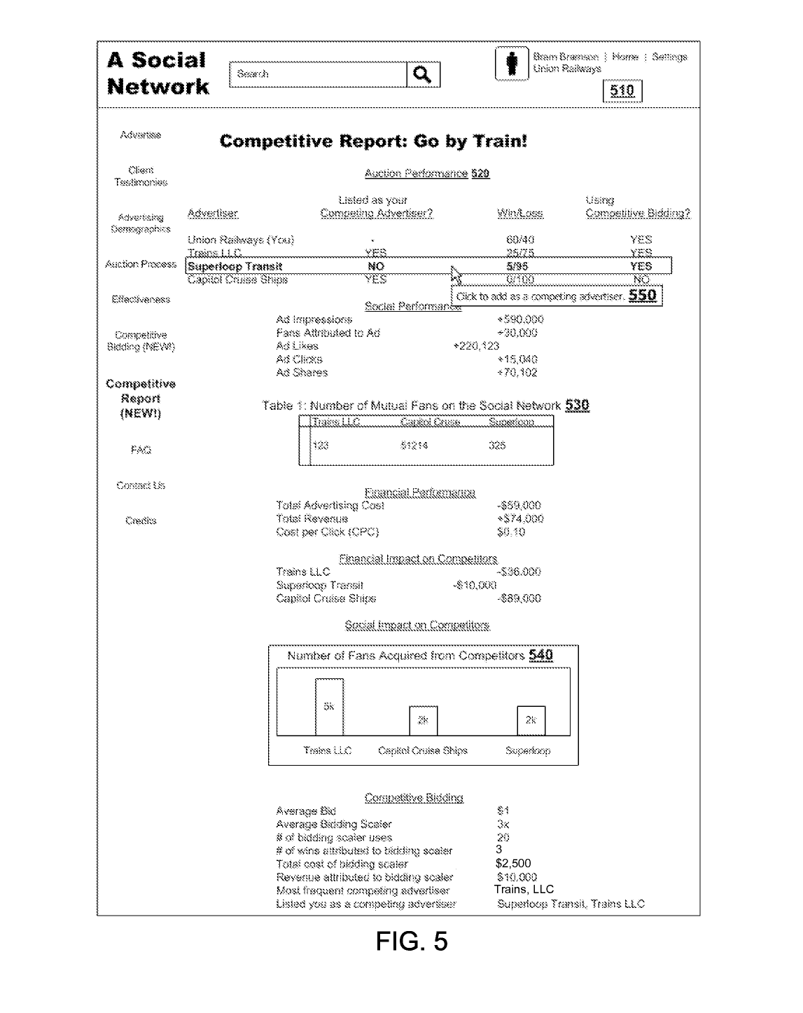

FIG. 5 shows one embodiment of a competitive report interface provided for display on a website administered by the social networking engine 140. While this example of a competitive report is displayed on a social networking website, the competitive report may be displayed to the advertiser in other forms. Different embodiments of the competitive report interface may include additional or alternative features.

This particular example of a competitive report comprises a set of advertisement performance metrics 520, 530, 540 and a competitive bidding option 550. The advertiser may provide a set of login information 510 to access the competitive report, as access to the competitive report may be restricted or considered private such that competing advertisers cannot view the competitive report. The competitive report comprises advertisement performance metrics 520, 530, 540 including, for example, auction performance metrics, social performance metrics, financial performance metrics, and competitive metrics. The metrics may be displayed to the advertiser as text 520 or in alternative mediums, such as a table 530 or a graph 540. However, advertisement performance metrics may be presented in any suitable format including text, video, graphics, audio, tables, charts, or interactive programs. The competitive report includes an option 550 to implement the competitive bidding scaler tool against a competing advertiser. The option 550 may be implemented as a hyperlink, a button, a pop-up, an email, or any other means of notifying an advertiser familiar to a person having ordinary skill in the art.

### SUMMARY

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the embodiments, which is set forth in the following claims.

What is claimed is:

1. A computer-implemented method comprising:
conducting an online advertising auction to determine an advertisement to select for a viewing user from a plurality of advertisements that are eligible to be shown to the viewing user;
determining that both a first advertisement request for an advertiser and a second advertisement request for a competitor of the advertiser are in the online advertising auction; and
based on the determination, applying a bidding scaler to a bid price associated with the first advertisement request to increase the bid price of the first advertisement request in the online advertising auction.

2. The computer-implemented method of claim 1, further comprising:
receiving a specification that identifies one or more advertisers that are competitors of the advertiser.

3. The computer-implemented method of claim 1, further comprising:
receiving a bidding scaler for adjusting bid prices of the advertiser in online advertising auctions.

4. The computer-implemented method of claim 3, wherein the bidding scaler is received by an ad publishing system from the advertiser and wherein the advertiser may specify a set of additional conditions for when the bidding scaler is applied to the bid price.

5. The computer-implemented method of claim 1, wherein the bidding scaler is a multiplier that increases the bid price when at least one of competitor of the advertiser participates in the online advertising auction with the advertiser.

6. The computer-implemented method of claim 1, wherein the bidding scaler is specific to an ad campaign, and wherein different bidding scalers are applied in different ad campaigns.

7. The computer-implemented method of claim 1, wherein competitors of the advertiser represent brands, companies, products or categories of competition that submit rival ad requests to an ad publishing system.

8. The computer-implemented method of claim 1, wherein the competitor of the advertiser is determined to be in the online advertising auction based in part on:
targeting criteria associated with the second advertisement request; and
advertising content in the second advertisement request.

9. The computer-implemented method of claim 1, wherein the advertisement to which the bidding scaler is applied is not shown to a holdout set of advertisement viewers in order to collect competitive metric data.

10. A system comprising:
a processor;
a computer-readable storage medium coupled to the processor, the computer-readable storage medium including instructions that, when executed by the processor, cause the processor to:
conduct an online advertising auction to determine an advertisement to select for a viewing user from a plurality of advertisement requests that are eligible to be shown to the viewing user;
determine that both a first advertisement request for an advertiser and a second advertisement request for a competitor of the advertiser are in the online advertising auction; and
based on the determination, apply a bidding scaler to a bid price associated with the first advertisement request to increase the bid price of the first advertisement request in the online advertising auction.

11. The system of claim 10, wherein the instructions further cause the processor to:
receive a specification that identifies one or more advertisers that are competitors of the advertiser.

12. The system of claim 10, wherein the instructions further cause the processor to:
receive a bidding scaler for adjusting bid prices of the advertiser in online advertising auctions.

13. The system of claim 12, wherein the bidding scaler is received by an ad publishing system from the advertiser and wherein the advertiser may specify a set of additional conditions for when the bidding scaler is applied to the bid price.

14. The system of claim 10, wherein the bidding scaler is a multiplier that increases the bid price when at least one competitor of the advertiser participates in the online advertising auction with the advertiser.

15. The system of claim 10, wherein the bidding scaler is specific to an ad campaign, and wherein different bidding scalers are applied in different ad campaigns.

16. The system of claim 10, wherein competitors of the advertiser represent brands, companies, products or categories of competition that submit rival ad requests to an ad publishing system.

17. The system of claim 10, wherein the competitor of the advertiser is determined to be in the online advertising auction based in part on:
targeting criteria associated with the second advertisement request; and
advertising content in the second advertisement request.

18. The system of claim 10, wherein the system is configured to not show the advertisement to which the bidding scaler is applied to a holdout set of advertisement viewers in order to collect competitive metric data.

19. A computer program product comprising a computer-readable storage medium containing computer program code for:
conducting an online advertising auction to determine an advertisement to select for a viewing user from a plurality of advertisement requests that are eligible to be shown to the viewing user;
determining that both a first advertisement request for an advertiser and a second advertisement request for a competitor of the advertiser are in the online advertising auction; and
based on the determination, applying a bidding scaler to a bid price associated with the first advertisement request to increase the bid price of the first advertisement request in the online advertising auction.

20. The computer program product of claim 19, further comprising program code for:
receiving a specification that identifies one or more advertisers that are competitors of the advertiser.

21. The computer program product of claim 19, further comprising program code for:
receiving a bidding scaler for adjusting bid prices of the advertiser in online advertising auctions.

22. The computer program product of claim 21, wherein the bidding scaler is received by an ad publishing system from the advertiser and wherein the advertiser may specify a set of additional conditions for when the bidding scaler is applied to the bid price.

23. The computer program product of claim 19, wherein the bidding scaler is a multiplier that increases the bid price when at least one competitor of the advertiser participates in the online advertising auction with the advertiser.

24. The computer program product of claim 19, wherein the bidding scaler is specific to an ad campaign, and wherein different bidding scalers are applied in different ad campaigns.

25. The computer program product of claim 19, wherein competitors of the advertiser represent brands, companies, products or categories of competition that submit rival ad requests to an ad publishing system.

26. The computer program product of claim 19, wherein the competitor of the advertiser is determined to be in the online advertising auction based in part on:
targeting criteria associated with the second advertisement request of; and
advertising content in the second advertisement request of.

27. The computer program product of claim 19, wherein the advertisement to which the bidding scaler is applied is not shown to a holdout set of advertisement viewers in order to collect competitive metric data.
